(19) United States
(12) Patent Application Publication
(10) Pub. No.: US 2013/0263616 A1
(43) Pub. Date: Oct. 10, 2013

(54) Fresh-water production, salt-solution concentration, volatile-matter extraction, air conditioning/refrigeration, thermal heat pump, low-temperature heat energy upgrading, and electricity generation

(71) Applicant: Chaloke Pungtrakul, Bangkok (TH)

(72) Inventor: Chaloke Pungtrakul, Bangkok (TH)

(21) Appl. No.: 13/442,888

(22) Filed: Apr. 10, 2012

(51) Int. Cl. B01D 3/00; F28D 15/00; F25B 15/00

(52) U.S. Cl. 62/101; 165/104.19; 203/22

(57) ABSTRACT

In a devolatilization/solution concentration process, the feed stream is pre-heated and further heated to a temperature which is higher than the normal boiling point, evaporated into a circulating gaseous medium to obtain a concentrated stream, and the vapor in the circulating gaseous medium is condensed to provide the pre-heating and produce a condensed stream. Increasing the temperature span between the heated stream and the cooled, concentrated stream provides more energy for evaporation into the circulating gaseous medium and improves the performance. The process is thus better adapted for fresh-water production, salt-solution concentration, volatile-matter extraction, air conditioning, refrigeration, low-temperature heat energy upgrading, and electricity generation. Examples of the relevant applications are also provided.

### FIELD OF THE INVENTION

This invention relates to the process of extracting a volatilizable constituent from a solution, particularly, an aqueous solution, and the uses of the resultant concentrated solution or the volatilizable constituent obtained in various applications, such as, in the capture of moisture from the air, in the drying of wet materials, in air conditioning or refrigeration, in the conversion of low-temperature heat energy to high-temperature heat energy, and in electricity generation.

### BACKGROUND OF THE INVENTION

In the extraction of fresh water from aqueous solutions, such as sea water, the heat of condensation has been re-utilized to minimize the evaporation energy requirement. In particular, U.S. Pat. No. 614,776 (John Stocker, 1897) had run water from the bottom of cooling tower 5 through pipes 14 in condensing tower 13, then over heat pipes 17 at the top of cooling tower 5. 2-4 times as much water could be evaporated compared to direct evaporation.

U.S. Pat. No. 3,317,406 (Kim D. Beard, 1963) had flowed cool saline fluid into condenser A provided with condensing coils 20 to condense the vaporized fluid, then into a solarheated evaporator B having a tray arrangement, while blower 70 introduced hot air into the evaporator. Unvaporized fluid in the evaporator was also recirculated back into the trays.

U.S. Pat. No. 3,345,272 (U.S. Secretary of the Interior, 1965) had heated a contaminated liquid to below the boiling point, passed the heated liquid counter-current to a gas in a packed tower, channelled the gas-vapor mixtures from plurality of points to plurality of condensers, and recycled the gas.

U.S. Pat. No. 3,522,151 (Albert B. Dismore, 1968) had evaporated salt water in evaporating chamber 2 in heat exchange with condensing chamber 44, heated the air from the evaporating chamber to a given temperature, sprayed unevaporated liquid 14 from the evaporating chamber into the heated air, and circulated the saturated air through the condensing chamber.

U.S. Pat. No. 3,822,192 (Aluminum Co., 1971) had passed a liquid containing up to 7.5% dissolved solid and a vapor carrier gas down a chamber having downwardly increasing temperature profile, applied heat at the bottom, and moved the gas-vapor mixture up along the outside of the chamber with condensation occurring on the outside of the chamber. The performance was 2-4.5.

U.S. Pat. No. 3,860,492 (Alvin Lowi, Jr., 1973) had pumped sea water through condenser coils 46 on one side of barrier wall 44 in chamber 42 and through a heat source 56 at 170 F onto fishing nets 68 on the other side of the barrier wall into sump 74, while air was circulated through the fishing nets counter-currently and onto the condenser coils in a closed loop. The coefficient of performance was 1.5-8.5.

U.S. Pat. No. 4,363,703 (Insitute of Gas Technology, 1980) had cooled warm, moist air 51 with cold sea water 50, solar heated 20% of the pre-heated sea water, and wetted evaporative medium 12 with both the remaining pre-heated sea water and the solar heated sea water, while ambient air was blown through the evaporative medium in order to produce the warm, moist air.

U.S. Pat. No. 4,832,115 (Albers Technologies Corp., 1986) and U.S. Pat. No. 4,982,782 (Walter F. Albers, 1989) had moved 0.06 m3/min. of air into evaporating chamber 34 to evaporate water vapor from 100 ml/minute of brackish feed in basin 40, while the energy was furnished from side 58 of partition 32 where condensation occurred, then further heated the gas in heat exchanger 15 with 0.23 kg/hour of steam to 80 C into condensing chamber 36. 33 ml/minute of condensate was discharged from basin 42 through port 52. The performance factor was 8.

Although the prior art had been able to achieve coefficient of performance or COP up to about 8 which is already fairly high (the performance, coefficient of performance, or performance factor is herein defined as the ratio of the heat that would otherwise be required to the heat actually supplied), there is still a need to further improve the performance. In particular, a coefficient of performance in the range of 10-20 or even higher would be greatly desirable.

### SUMMARY OF THE INVENTION

The object of the present invention is to improve the above type of devolatilization/solution concentration process in order to better adapt it to various uses.

The present invention is basically based on the discovery that if the evaporation commences at a temperature which is higher than the normal boiling point of the feed stream instead of below or near the normal boiling point of the feed stream as in the prior art, the coefficient of performance can significantly be improved. Moreover, even if the feed solution comprises a dissolved desiccant or a volatilizable constituent having a high affinity to the water, which would not so easily evaporate into the circulating air, the performance can still be greatly improved.

Thus, according to a first aspect, the present invention provides a process which comprises pre-heating a feed stream from an initial temperature to an intermediate temperature, further heating the pre-heated stream to a slightly higher temperature, but higher than the normal boiling point of the feed stream, evaporating a part of the heated stream into a circulating gaseous medium to cool the remaining, concentrated stream to a temperature just slightly higher than the initial temperature of the feed stream, condensing the vapor in the circulating gaseous medium to provide said pre-heating of the feed stream and produce a condensed stream, and recycling at least a part of the vapor-depleted gaseous medium as said circulating gaseous medium. Since the temperature of the heated stream has been increased compared to conventional, the temperature difference between the heated stream and the cooled, concentrated stream would consequently be increased, providing more heat energy for evaporation into the circulating gaseous medium and improving the performance.

According to a second aspect of the present invention, the feed stream would comprise a dilute aqueous solution containing a dissolved desiccant, and the cooled, concentrated desiccant solution would be put to further uses, such as in the capture of moisture from the air, in the drying of wet materials, in air conditioning/refrigeration, in the conversion of low-temperature heat energy to high-temperature heat energy, and in electricity generation.

According to a third aspect of the present invention, the feed stream would comprise a rich aqueous solution containing a relatively high amount of a dissolved volatile-matter, and the condensed volatile-matter stream would be put to further uses, such as in refrigeration, in the conversion of low-temperature heat energy to high-temperature heat energy, and in electricity generation.

The above and other objects and advantages of the present invention will more readily apparent upon the reading of the Detailed Description.

### BRIEF DESCRIPTION OF THE DRAWINGS

FIG. 1 is a schematic process flow diagram illustrating a basic volatile extraction/solution concentration process according to an embodiment of the present invention.

FIG. 2 is a graph showing relationships between the heated water temperature and the coefficient of performance.

FIG. 3 is a schematic process flow diagram illustrating a fresh-water production process according to another embodiment of the present invention.

FIG. 4 is a schematic process flow diagram illustrating a fresh-water production process according to a further embodiment of the present invention.

FIG. 5 is a schematic process flow diagram illustrating a wet-material drying process according to a further embodiment of the present invention.

FIG. 6 is a schematic process flow diagram illustrating an air conditioning process according to a further embodiment of the present invention.

FIG. 7 is a schematic process flow diagram illustrating an absorption refrigeration process according to a further embodiment of the present invention.

FIG. 8 is a schematic process flow diagram illustrating an electricity generation process according to a further embodiment of the present invention.

FIG. 9 is a schematic process flow diagram illustrating another absorption refrigeration process according to a still further embodiment of the present invention.

FIG. 10 is a schematic process flow diagram illustrating another electricity generation process according to a still further embodiment of the present invention.

FIG. 11 is a schematic process flow diagram illustrating a low-temperature heat energy upgrading process according to a further embodiment of the present invention.

FIG. 12 is a schematic process flow diagram illustrating a possible integration of the low-temperature heat energy upgrading process shown in FIG. 11 with the electricity generation process shown in FIG. 8 according to a still further embodiment of the present invention.

### DETAILED DESCRIPTION OF THE INVENTION

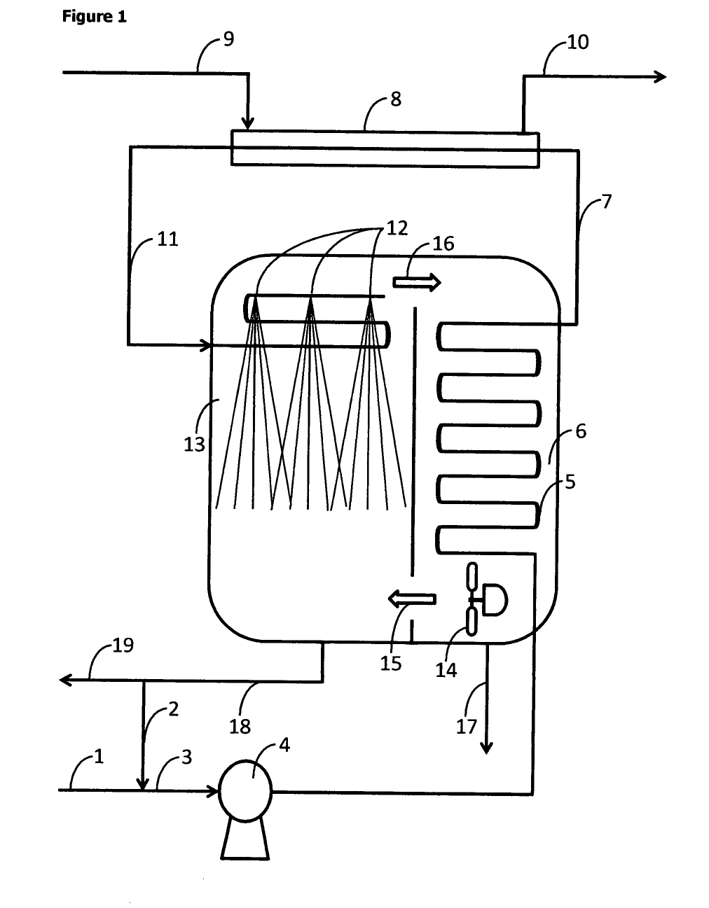

A basic devolatilization/solution concentration process according to the present invention is shown in FIG. 1, wherein make-up steam 1 and recycle stream 2 are combined into feed stream 3 and fed by pump 4 through pre-heating coil 5 in condensing chamber 6 to provide pre-heated stream 7. The pre-heated stream 7 is then heated in heat exchanger 8 equipped with heating medium inlet 9 and heating medium outlet 10, and the heated stream 11 is sprayed through nozzles 12 into an upper portion of evaporating chamber 13, while fan 14 circulates cooled air 15 from a lower portion of the evaporating chamber up to the upper portion counter-currently. The heated, vapor-loaded air 16 is then passed from an upper portion of an adjacent condensing chamber 6 down over cooling coil 5, and the cooled air is re-circulated by fan 14. The condensed vapor collected at the bottom of the condensing chamber is withdrawn as condensed stream 17, while the cooled, concentrated stream 18 is withdrawn from the bottom of the evaporating chamber and divided into recycle stream 2 and purge stream 19.

According to the present invention, the evaporation of the heated stream 11 into recirculated air 15 will commence at a temperature higher than the normal boiling point of the feed stream 3. Tables 1 and 2 below demonstrate the cases when 30% of sea water 1 at a temperature of 30 C and a salt concentration of 3.5% are combined with 70% of recycle water 2 into feed stream 3, pre-heated to the various temperatures, then heated to slightly higher temperatures and sprayed into evaporating chamber 13. The only differences between Table 1 and Table 2 are that the air is cooled to within 5 C and 3 C of the feed water temperature before entering the evaporating chamber and also heated to within 5 C and 3 C of the heated water temperature before leaving the evaporating chamber, respectively. From Table 1, it can be seen that when the heated water temperature is increased from 90 C to 120 C, 150 C, 180 C and 210 C, since the heated water will be cooled in evaporating tower 13 to about 63.3 C, the heat available for evaporation will increase from 10358301 Btu/hr to 21127671 Btu/hr, 30489563 Btu/hr, 38357492 Btu/hr, and 44725164 Btu/hr, and the COP will increase

TABLE 1
Temperature approaches 5 C.
Make-up Water/Recycle Water Mixing

| | | | | | |
|---|---|---|---|---|---|
| Make-up water temp., C. | 30 | 30 | 30 | 30 | 30 |
| Salt concentration, % | 3.5 | 3.5 | 3.5 | 3.5 | 3.5 |
| Make-up water flow, L/min. | 507.3 | 484.3 | 460 | 434.4 | 407.4 |
| % | 30 | 30 | 30 | 30 | 30 |
| Recycle water temp., C. | 63.3 | 63.3 | 63.3 | 63.3 | 63.3 |
| Recycle salt concentration, % | 4.14 | 5.22 | 7.02 | 10.55 | 20.66 |
| Recycle water flow, L/min. | 1183.7 | 1130 | 1073.3 | 1013.5 | 950.7 |
| % | 70 | 70 | 70 | 70 | 70 |

Feed Water Pre-Heating/Heating

| | | | | | |
|---|---|---|---|---|---|
| Feed water temp., C. | 53.3 | 53.3 | 53.3 | 53.3 | 53.3 |
| Salt concentration, % | 3.95 | 4.71 | 5.97 | 8.43 | 15.51 |
| Feed water flow, L/min. | 1691 | 1614.3 | 1533.3 | 1447.9 | 1358.1 |
| Pre-heated water temp., C. | 80 | 110 | 140 | 170 | 200 |
| Sensible heat, Btu/hr | 10726274 | 21760655 | 31610930 | 40183769 | 47385105 |
| Heated water temp., C. | 90 | 120 | 150 | 180 | 210 |
| Sensible heat, Btu/hr | 4022529 | 3840195 | 3647464 | 3444337 | 3230813 |
| Pump efficiency, % | 70 | 70 | 70 | 70 | 70 |
| Pump electricity, kW | 1.983 | 6.893 | 16.99 | 34.59 | 61.76 |
| HP | 2.658 | 9.24 | 22.77 | 46.37 | 82.78 |

Water Evaporation

| | | | | | |
|---|---|---|---|---|---|
| Saturated return air temp., C. | 58.3 | 58.3 | 58.3 | 58.3 | 58.3 |
| Return air flow, ft3/min. | 5055 | 1376 | 310.9 | 62.67 | 11.75 |
| Saturated outlet air temp., C. | 85 | 115 | 145 | 175 | 205 |
| Heat of evaporation, Btu/hr | 10358301 | 21127671 | 30489563 | 38357492 | 44725164 |
| Sensible heat, Btu/hr | 367973 | 632985 | 1121367 | 1826277 | 2659941 |
| Change in heat, Btu/hr | 10726274 | 21760656 | 31610930 | 40183769 | 47385105 |

Moisture Condensation

| | | | | | |
|---|---|---|---|---|---|
| Moisture condensation, m3/hr | 4.703 | 9.592 | 13.842 | 17.414 | 20.305 |
| Coefficient of performance | 2.575 | 5.502 | 8.359 | 11.136 | 13.843 |

from 2.575 to 5.502, 8.359, 11.136, and 13.843, respectively, and from Table 2, it can be seen that when the heated water temperature is increased from 86 C to 116

TABLE 2
Temperature approaches 3 C.
Make-up Water/Recycle Water Mixing

| | | | | | |
|---|---|---|---|---|---|
| Make-up water temp., C. | 30 | 30 | 30 | 30 | 30 |
| Salt concentration, % | 3.5 | 3.5 | 3.5 | 3.5 | 3.5 |
| Make-up water flow, L/min. | 850.4 | 812.4 | 772.2 | 729.8 | 685.2 |
| % | 30 | 30 | 30 | 30 | 30 |
| Recycle water temp., C. | 50 | 50 | 50 | 50 | 50 |
| Recycle salt concentration, % | 4.41 | 5.67 | 7.84 | 12.45 | 29.25 |
| Recycle water flow, L/min. | 1984.3 | 1895.6 | 1801.7 | 1702.8 | 1598.8 |
| % | 70 | 70 | 70 | 70 | 70 |

Feed Water Pre-Heating/Heating

| | | | | | |
|---|---|---|---|---|---|
| Feed water temp., C. | 44 | 44 | 44 | 44 | 44 |
| Salt concentration, % | 4.14 | 5.02 | 6.54 | 9.77 | 21.53 |
| Feed water flow, L/min. | 2835 | 2708 | 2574 | 2433 | 2284 |
| Pre-heated water temp., C. | 80 | 110 | 140 | 170 | 200 |
| Sensible heat, Btu/hr | 24276326 | 42516172 | 58780195 | 72912444 | 84756970 |
| Heated water temp., C. | 86 | 116 | 146 | 176 | 206 |
| Sensible heat, Btu/hr | 4046054 | 3865107 | 3673762 | 3472021 | 3259883 |
| Pump efficiency, % | 70 | 70 | 70 | 70 | 70 |
| Pump electricity, kW | 7.604 | 11.96 | 26.22 | 53.13 | 96 |
| HP | 10.193 | 16.036 | 35.143 | 71.219 | 128.68 |

Water Evaporation

| | | | | | |
|---|---|---|---|---|---|
| Saturated return air temp., C. | 47 | 47 | 47 | 47 | 47 |
| Return air flow, ft3/min. | 10846 | 2792 | 608.3 | 119.9 | 22.17 |
| Saturated outlet air temp., C. | 83 | 113 | 143 | 173 | 203 |
| Heat of evaporation, Btu/hr | 23230682 | 41084336 | 56478574 | 69346347 | 79714355 |
| Sensible heat, Btu/hr | 1045644 | 1431836 | 2301621 | 3566097 | 5042615 |
| Change in heat, Btu/hr | 24276326 | 42516172 | 58780195 | 72912444 | 84756970 |

Moisture Condensation

| | | | | | |
|---|---|---|---|---|---|
| Moisture condensation, m3/hr | 10.547 | 18.652 | 25.641 | 31.483 | 36.19 |
| Coefficient of performance | 5.742 | 10.63 | 15.373 | 19.973 | 24.453 |

C, 146 C, 176 C, and 206 C, since the heated water will be cooled in the evaporating chamber to about 5° C., the heat available for evaporation will increase from 23230682 Btu/hr to 41084336 Btu/hr, 56478574 Btu/hr, 69346347 Btu/hr, and 79714355 Btu/hr, and the COP will increase from 5.742 to 10.630, 15.373, 19.973, and 24.453, respectively. It can thus be seen that the greater span between the heated water temperature and the cooled, residual sea water temperature remarkably increases the evaporation and improves the performance.

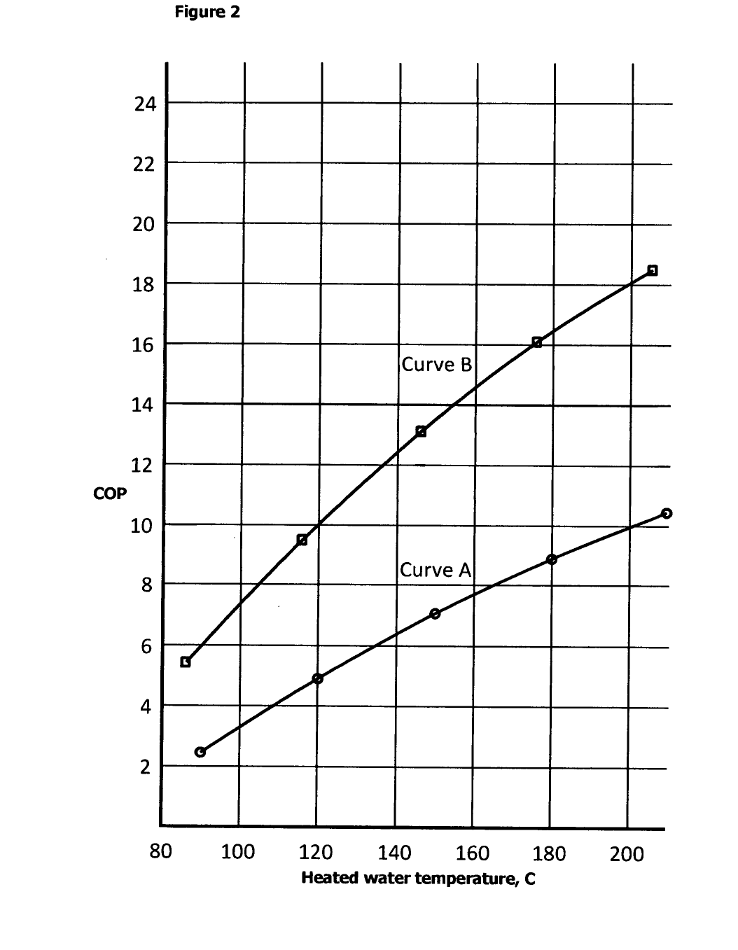

The relationships between the heated water temperature and the coefficient of performance depicted in Tables 1 and 2 have also been plotted in FIG. 2 as Curves A and B, respectively. From the lower left-hand corner of the graph, it can be seen that if the heated water temperature were limited to the normal boiling point of 100 C, the COP would increase only if the temperature approaches were reduced (such as by improvement in the equipment construction and so forth) and then would be limited to only about 8.

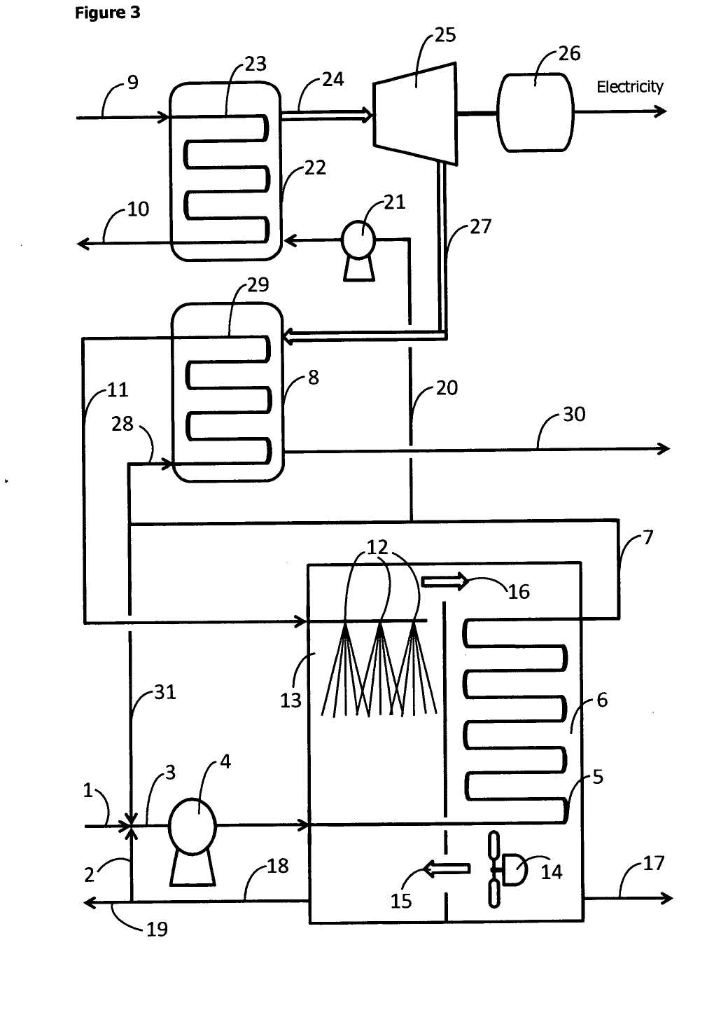

The improvement attained by increasing the heated water temperature, however, does come with a price. For example, if the heated water temperature were increased from 86 C to 206 C, the corresponding pressure would also increase from 0.5 atm to 17.5 atm, and, as shown in Table 2, the pumping electricity requirement would also increase from 7.604 kW to 96 kW. To circumvent this problem, a part of pre-heated water 7 could be boiled, the steam passed through an expansion turbine to generate the required electricity, and the turbine exhaust then condensed in heat exchanger 8 to heat the remaining pre-heated water 7. According to the arrangement shown in FIG. 3, make-up steam 1 and recycle stream 2 are also combined into feed stream 3 and fed by pump 4 through pre-heating coil 5 in condensing chamber 6 to provide pre-heated stream 7, but a minor part 20 of the pre-heated stream 7 is further fed by pump 21 into boiler 22 equipped with heating medium inlet 9, heating coil 23, and heating medium outlet 10. Steam 24 from boiler 22 is then passed through expansion turbine 25 coupled to electricity generator 26, and turbine exhaust 27 is condensed in condenser 8 to heat a major part 28 of the pre-heated stream 7 in coil 29, producing condensed stream 30. A small amount of excess pre-heated stream 31 could also be combined with make-up stream 1 and recycle stream 2 into feed stream 3. The heated stream 11 is then sprayed through nozzles 12 into evaporating chamber 13, while fan 4 circulates cooled air 15 from a lower portion of evaporating chamber 13 up to the upper portion counter-currently. The heated, vapor-loaded air 16 is then passed from an upper portion of condensing chamber 6 down over cooling coil 5, and the cooled air is recirculated by fan 14. The condensed vapor at the bottom of condensing chamber 6 is withdrawn as condensed stream 17, while the cooled and concentrated stream 18 is withdrawn from the bottom of evaporating chamber 13 and divided into recycle stream 2 and purge stream 19 as before.

For example, 405.8 L/minute of sea water 1 at a temperature of 30 C and a salt concentration of 3.5% may be combined with 801.0 L/minute of recycle water 2 and 2.2 L/minute of excess pre-heated water 31 into feed stream 3 having a temperature of 50 C and pre-heated 5 to 120 C. 23.9 L/minute of pre-heated water 20 may be pumped 21 into boiler 22, and 4,932 L/minute of steam 24 at a temperature of 176 C and a pressure of 9.1 atm may be passed through expansion turbine 25 to generate 43.0 kW. Turbine exhaust 27 at 141.5 C may be condensed in condenser 8 to heat 1,182.9 L/minute of pre-heated water 28 in coil 29 to 131.5 C and produce 23.9 L/10 minute of condensate 30. The heated water 11 may be sprayed 12 into evaporating chamber 13 counter-current to 665.5 ft3/minute of cooled, saturated air 15 at 55 C. The heated, saturated air 16 at 125 C may be cooled in condensing chamber 6 to produce 147.5 L/minute of condensate 17, and 234.1 L/minute of the evaporating chamber's bottom water 18 may be purged 19. In this case, the COP will be 6.54. Since pump 4 will require 8.213 kW, pump 21 will require 0.525 kW, and fan 4 will require 5.120 kW, there will be a net surplus electricity of 29.1 kW or 67.8% of the generated electricity. Even though the fresh-water production COP is slightly lowered due to the energy expended in electricity generation, which has reduced the steam temperature from 176 C to 141.5 C (as can be seen from Curve A in FIG. 2), the surplus electricity should more than off-set the slightly lower fresh-water revenue. Neither reverse osmosis nor multi-stage flash evaporation would also produce electricity.

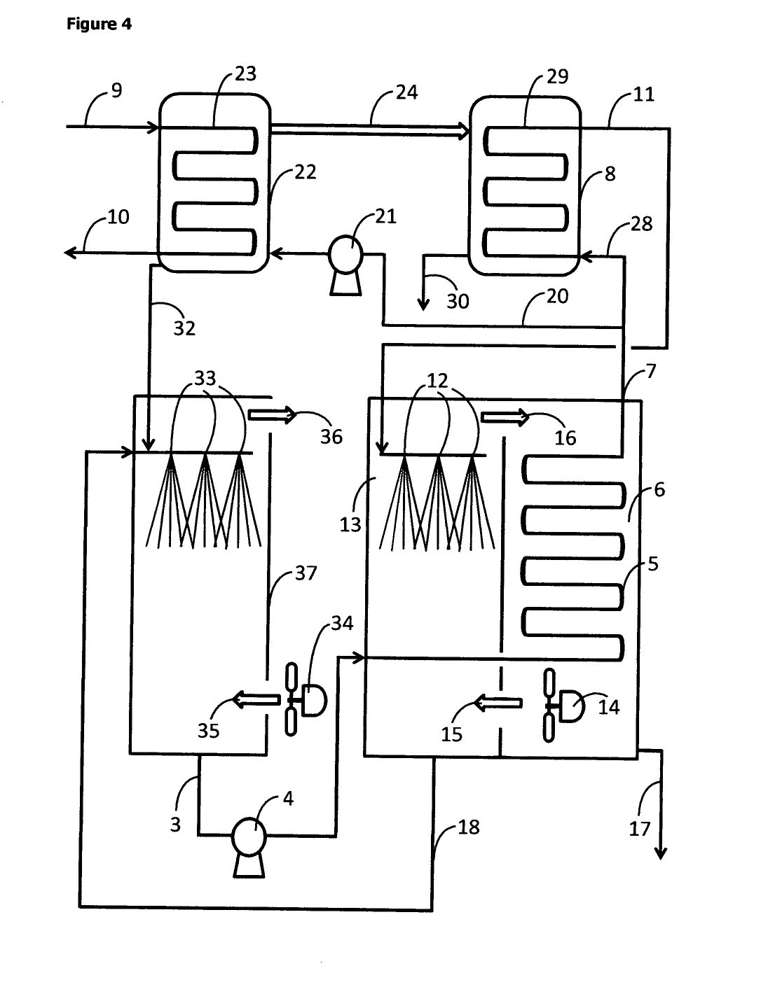

As mentioned earlier, the use of higher heating temperature is also beneficial even when the feed solution contains a dissolved desiccant having a high affinity to water. In order to demonstrate this point, FIG. 4 has shown a process to capture moisture in the air and recover the water from diluted desiccant solution. For example, 65.126 kg/minute of 45.1% CaCl2 solution 3 at 44.7 C may be fed by pump 4 and pre-heated in coil 5 of condensing chamber 6 to 225 C. 3.624 kg/minute of pre-heated solution 20 may be further pumped 21 into boiler 22 to produce 0.717 kg/minute of steam 24 at 292.1 C, 33.1 atm and 2.907 kg/minute of 56.2% CaCl2 solution 32. The steam 24 may be condensed in condenser 8 at 240 C to heat 61.503 kg/minute of the remaining pre-heated solution 28 in coil 29 to 235 C and produce condensate stream 30. The heated solution 11 may be sprayed through nozzles 12 into evaporating chamber 13 counter-current to 1.084 ft3/minute of cooled, saturated air 15 at 49.7 C. The heated air 16 at 230 C, relative humidity 38.4% may be cooled in condensing chamber 6 to produce 12.17 L/minute of condensate stream 17. 49.333 kg/minute of 56.2% CaCl2 solution 18 at 54.7 C and the concentrated solution 32, which has also been heat exchanged to 54.7 C (not shown), may be combined and sprayed through nozzles 33 in absorption tower 37 counter-current to 100,000 ft3/minute of ambient air 35 at 35 C, relative humidity 50% from fan 34. The air 36 leaving the absorption tower 37 will be at 44.7 C, relative humidity 22.4%, the combined condensate will amount to 773.15 L/hour (per 100,000 ft3/minute of ambient air), and the COP (the ratio between the heat of absorption and the heat input) will be 12.45. Since pump 4 will require 1.336 kW, pump 21 will require 0.147 kW, fan 14 will require 0.730 kW, and fan 34 will require 1.549 kW, the total electricity consumption will be 3.762 kW (4.866 kwh/m3 of water). Although the steam 24 and the condensate 30 could be used to generate electricity, other processes described herein below would be more efficient.

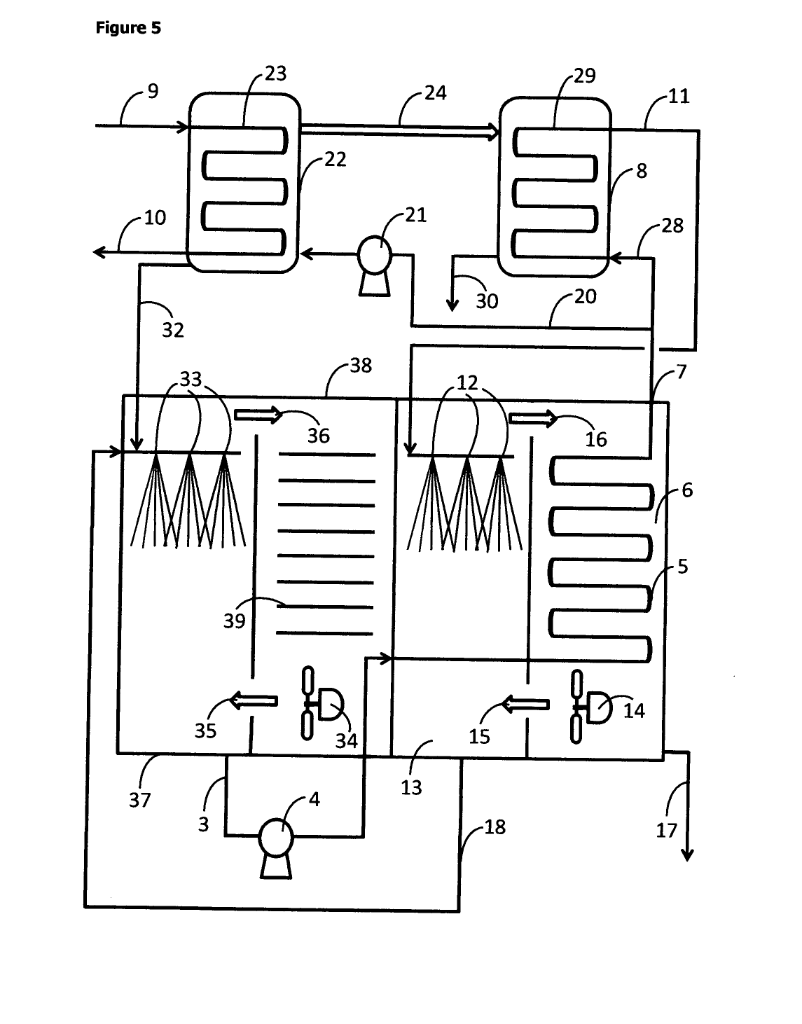

The wet-material drying process shown in FIG. 5 is also based on adiabatic moisture absorption, the only difference being in that the air is dehumidified and recycled to a drying cabin in a closed loop. For example, 7.953 kg/minute of 51% CaCl2 solution 3 at 120 C may be pre-heated 5 to 305 C. 0.421 kg/minute of pre-heated solution 20 may be boiled 22 to produce 0.088 kg/minute of steam 24 at 388.9 C, 111.3 atm and 0.333 kg/minute of 64.6% CaCl2 solution 32. The steam 24 may be condensed 8 at 320 C to heat 7.531 kg/minute of the remaining pre-heated solution 28 to 315 C and produce condensate 30. The heated solution 11 may be sprayed through nozzles 12 counter-current to 0.0105 ft3/minute of cooled, saturated air 15 at 125 C. The heated air 16 at 310 C, relative humidity 36.6% may be cooled in condensing chamber 6 to produce 1.578 L/minute of condensate 17. (To condense the water vapor at 125 C, evaporating chamber 13 and condensing chamber 6 must be operated at 3.1 atm.) 5.953 kg/minute of 64.6% CaCl2 solution 18 at 130 C and the concentrated solution 32, which has been heat exchanged (not shown) to 187.9 C, may be combined and sprayed through nozzles 33 in absorption tower 37 countercurrent to 2,245 ft3/minute of moist air 35 at 80 C, relative humidity 93.4% from fan 34. The air 36 leaving the absorption tower 37 at 120 C, relative humidity 20.7% may be recycled to drying cabin 38 equipped with drying trays 39. The drying capacity in this case will be 100 kg of moisture/hour, all of the moisture will be recovered, and the COP will be 12.22. Since pump 4 will require 0.006 kW, pump 21 will require 0.090 kW, fan 14 will require 0.094 kW, and fan 34 will require 0.026 kW, the total electricity consumption will be 0.216 kW (or 2.16 kwh/m3 of water removed from the wet-material).

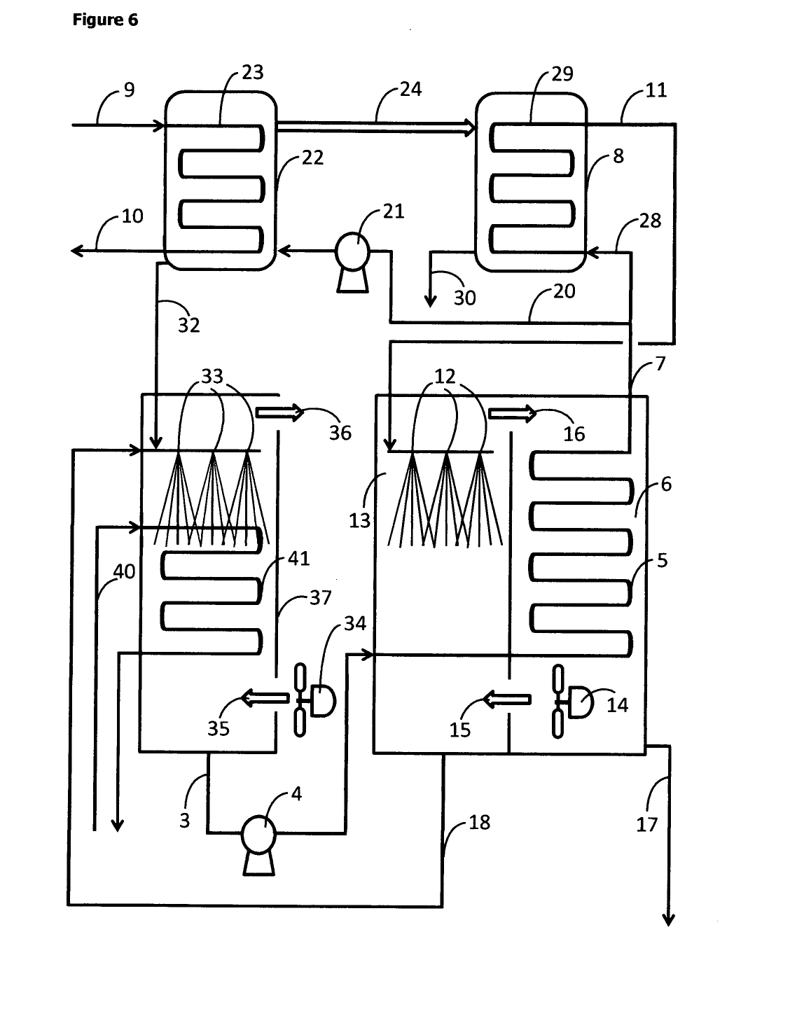

On the other hand, the air conditioning process shown in FIG. 6 is based on substantially isothermal dehumidification. For example, 1.819 kg/minute of 36.2% LiCl solution 3 at 32 C may be pre-heated in coil 5 (diameter 0.5 inch, length 240 ft) to 225 C. 0.103 kg/minute of pre-heated solution 20 may be boiled 22 (using 3,713 Btu/hr) to produce 0.023 kg/minute of steam 24 at 259.7 C, 33.3 atm and 0.080 kg/minute of 46.9% LiCl solution 32. The steam 24 may be condensed 8 at 240.3 C to heat 1.716 kg/minute of the remaining pre-heated solution 28 to 235.3 C, producing condensate 30. Heated solution 11 may be sprayed through nozzles 12 in evaporating chamber 13 (diameter 1.37 ft, height 3.43 ft) counter-current to 0.0091 ft3/minute of cooled, saturated air 15 at 37 C. The heated air 16 at 230.3 C, relative humidity 62.4% may be cooled in condensing chamber 6 to produce 0.386 L/minute of condensate stream 17. 1.331 kg/minute of 46.9% LiCl solution 18 at 42 C and the concentrated solution 32, which has been heat exchanged (not shown) to 43.1 C, may be combined and sprayed through nozzles 33 in absorption tower 37 countercurrent to 1,099 ft3/minute of ambient air 35 at 35 C, relative humidity 50% from fan 34, while 32.6 L/minute of cooling water 40 at 28 C is supplied to coil 41. The air 36 leaving the absorption tower 37 at 32 C, relative humidity 15.6% (wet-bulb temperature 15 C) may be humidified into the space to be conditioned. The cooling capacity in this case will be 60,000 Btu/15 hr, and the COP will be 16.16. Since pump 4 will require 0.001 kW, pump 21 will require 0.007 kW, fan 14 will require 0.046 kW, fan 34 will require 0.004 kW, and the cooling tower used to cool the water leaving coil 41 down to 28 C (not shown) will require 0.235 kW, the total electricity consumption will be 0.293 kW which compares favorably with a 5 kW compressor that would be necessary for similar function.

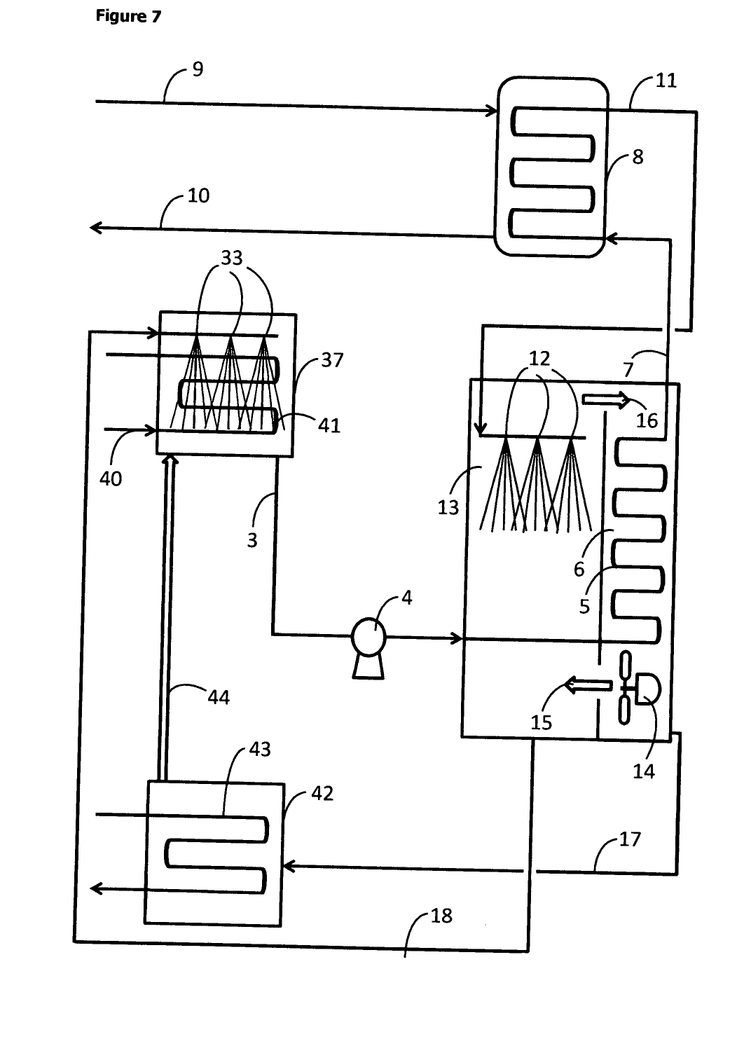

Air conditioning can also be provided by an absorption refrigeration process shown in FIG. 7. For example, 6.145 kg/minute of 46.4% NaOH solution 3 at 60 C, 0.01 atm may be pumped 4, pre-heated in coil 5 (diameter 0.5 inch, length 575 ft) to 197 C, heated in heat exchanger 8 (using 5,990 Btu/hr) to 203 C, 2.63 atm, and sprayed through nozzles 12 in evaporating chamber 13 (diameter 2.04 ft, height 5.09 ft) counter-current to 4.071 ft3/minute of saturated air 15 at 63 C. The heated air 16 at 200 C, relative humidity 13.1% may be cooled in condensing chamber 6 to produce 0.913 L/minute of condensate stream 17, which may be heat exchanged (not shown) to 8 C and evaporated in evaporator 42 to chill the water circulating through coil 43 to 8 C. 5.232 kg/minute of 54.5% NaOH solution 18 at 66 C may be sprayed through nozzles 33 in absorber 37 to absorb water vapor 44, which has been heated by the heat exchange from 5 C to 60 C, while 20.3 L/minute of cooling water 40 at 32 C is supplied to coil 41. The chilled water from coil 43 may be used to cool the space. The cooling capacity in this case will be 120,000 Btu/hr, and the COP will be 20.14. Since pump 4 will require 0.029 kW, fan 14 will require 0.102 kW, and the cooling tower used to cool the water leaving coil 41 down to 32 C (not shown) will require 0.173 kW, the total electricity consumption will be 0.304 kW, which compares favorably with a 10 kW compressor that would be necessary for similar function.

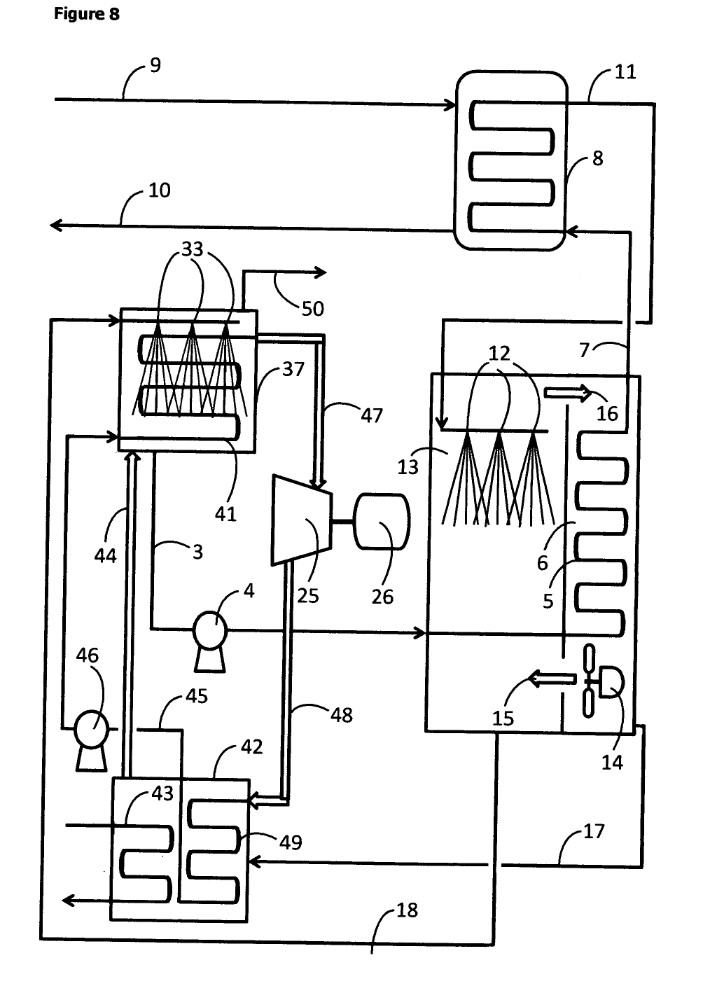

FIG. 8 has shown the case when exactly the same absorption refrigeration process as depicted in FIG. 7 is applied to electricity generation. For example, 10.26 kg/minute of 46.4% NaOH solution 3 at 60 C, 0.01 atm may be pumped 4, pre-heated in coil 5 (diameter 0.5 inch, length 714 ft) to 197 C, heated in heat exchanger 8(using 10,006 Btu/hr) to 203 C, 2.63 atm, and sprayed through nozzles 12 in evaporating chamber 13 (diameter 2.50 ft, height 6.25 ft) counter-current to 6.80 ft3/minute of saturated air 15 at 63 C. The heated air 16 at 200 C, relative humidity 13.1% may be cooled in condensing chamber 6 to produce 1.53 L/minute of condensate stream 17, which may be heat exchanged (not shown) to 8 C and evaporated in evaporator 42. 8.73 kg/minute of 54.5% NaOH solution 18 at 66 C may be sprayed through nozzles 33 in absorber 37 to absorb water vapor 44, which has been heated by the exchange from 5 C to 60 C. In another loop, 9.143 kg/minute of butane liquid 45 may be heat exchanged (not shown) from 10 C to 37.1 C and fed by pump 46 through coil 41 in absorber 37. The butane vapor 47 at 55 C, 5.58 atm may be expanded in turbine 25 coupled to electricity generator 26 to generate 3.399 kW. Turbine exhaust 48 at 42.1 C, 1.47 atm may be cooled by the heat exchange to 15 C and liquefied through coil 49 in evaporator 42 (in this case, coil 43 in evaporator 42 is not utilized). Since pump 4 will require 0.050 kW, fan 14 will require 0.154 kW, pump 46 will require 0.129 kW, and a cooling tower to remove some excess heat 50 (not shown) will require 0.066 kW, the net electricity will be 3.0 kW, and the coefficient of performance will be 1.023. Except for small estimation errors, a COP of 1 should be entirely feasible considering that the system is essentially closed with all of the heat energy supplied to the heat exchanger 8 being converted by the generator 26 into electricity.

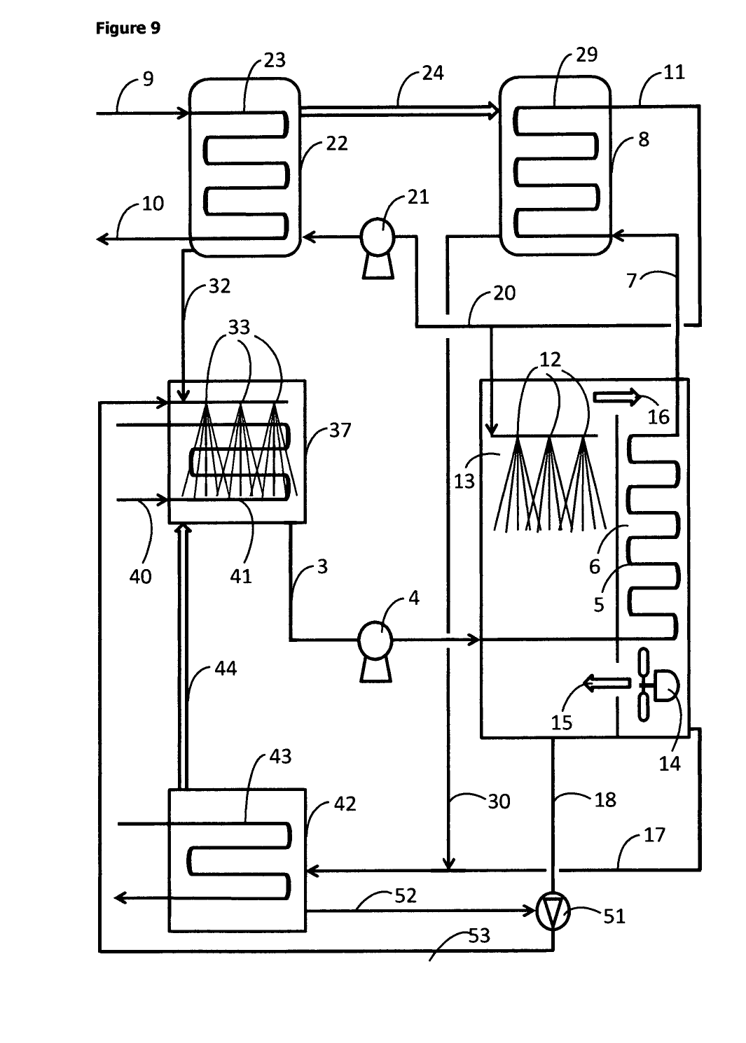

FIG. 9 is a variation of the absorption refrigeration process depicted in FIG. 7, and ammonia is used as refrigerant instead of water. For example, 3.530 kg/minute of 29.5% NH3 solution 3 at 60 C, 2.31 atm may be fed by pump 4, pre-heated in coil 5 to 120 C, heated in heat exchanger 8 to 124.4 C and divided. 0.166 kg/minute of the heated solution 20 may be fed by pump 21 into boiler 22 supplied with 3,243 Btu/hr to produce 0.017 kg/minute of 69.8% NH3 vapor 24 at 191.3 C, 17.75 atm and 0.149 kg/minute of 25.0% NH3 solution 32. The 69.8% NH3 vapor 24 may be condensed in heat exchanger 8 at 131.4 C to heat the pre-heated solution and produce 69.8% NH3 solution 30. The remaining 3.364 kg/minute of the heated solution 11 may be sprayed through nozzles 12 in evaporating chamber 13 counter-current to 11.65 ft3/minute of saturated air 15 at 67 C. The heated air 16 at 117.4 C may be cooled in condensing chamber 6 to produce 1.476 kg/minute of 67.2% NH3 solution 17 at 67 C, 6.15 atm which may be combined with the 69.8% NH3 solution 30, heat exchanged (not shown) to 60 C, and evaporated in evaporator 42 to chill the water circulating in coil 43. 1.889 kg/minute of bottom water 18 at 74 C, 6.15 atm may be fed to a jet pump 51 to entrain 0.489 kg/minute of bottom water 52 at 5 C, 2.31 atm, and the discharge 53 may be sprayed through nozzles 33 in absorber 37 along with the 25.0% NH3 solution 32 to absorb 1.003 kg/minute of NH3 vapor 44 at 5 C, 2.31 atm, while 7.735 L/minute of cooling water 40 at 29 C is supplied to coil 41. The chilled water from coil 43 may also be used to cool the space to be conditioned. The cooling capacity in this case will be 60,000 Btu/hr, and the COP will be 18.50. Since pump 4 will require 0.034 kW, pump 21 will require 0.005 kW, fan 14 will require 0.033 kW, and the cooling tower used to cool the water leaving coil 41 down to 29 C (not shown) will require 0.114 kW, the total electricity consumption will be 0.186 kW which compares favorably with a typical 5 kW compressor that would be necessary for similar function.

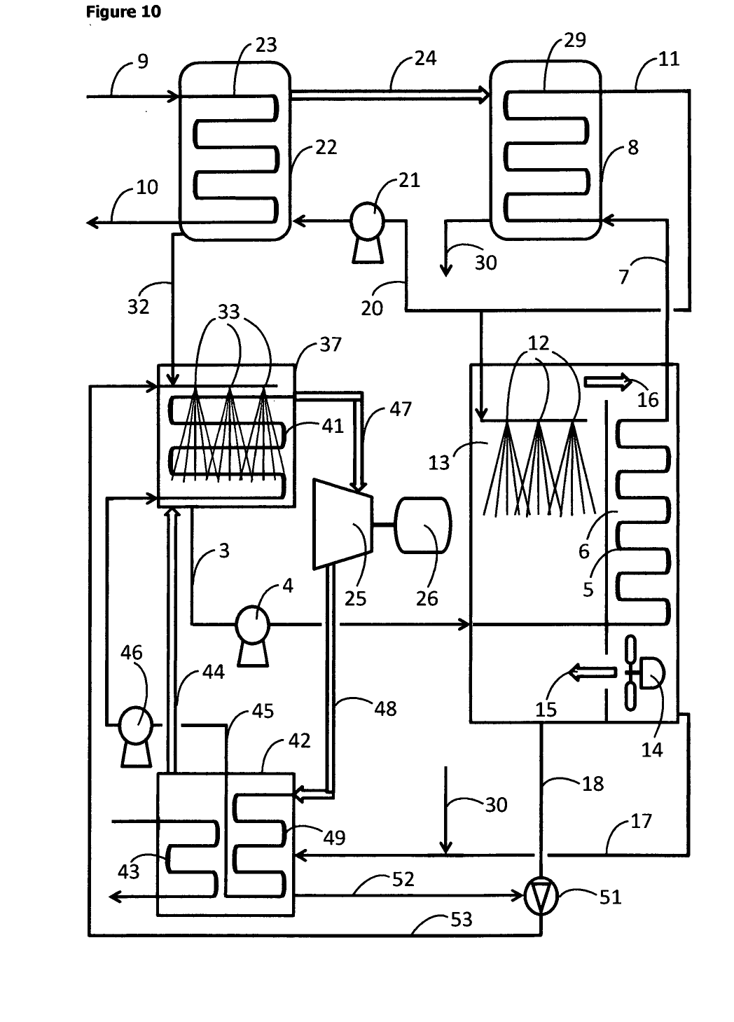

The absorption refrigeration process depicted in FIG. 9 can also be applied to electricity generation as shown in FIG. 10. For example, 12.519 kg/minute of 29.5% NH3 solution 3 at 60 C, 2.31 atm may be fed by pump 4, pre-heated in coil 5 to 120 C, heated in heat exchanger 8 to 120.7 C and divided. 0.087 kg/minute of the heated solution 20 may be fed by pump 21 into boiler 22 supplied with 1,653 Btu/hr of heat energy to produce 0.0085 kg/minute of 70.6% NH3 vapor 24 at 185.7 C, 16.62 atm and 0.078 kg/minute of 25.0% NH3 solution 32. The 70.6% NH3 vapor 24 may be condensed in heat exchanger 8 at 125.7 C to heat the pre-heated solution, producing 70.6% NH3 solution 30. The remaining 12.432 kg/minute of heated solution 11 may be sprayed through nozzles 12 in evaporating chamber 13 counter-current to 47.12 ft3/minute of saturated air 15 at 65 C. The heated air 16 at 115.7 C may be cooled in condensing chamber 6 to produce 5.414 kg/minute of 67.7% NH3 solution 17 at 65 C, 5.95 atm, which may be combined with the 70.6% NH3 solution 30, heat exchanged (not shown), and evaporated in evaporator 42. 7.018 kg/minute of bottom water 18 at 70 C, 5.95 atm may be fed to jet pump 51 to aspire 1.753 kg/minute of bottom water 52 at 5 C, 2.31 atm to nozzles 33 in absorber 37, which are also fed with the 25% NH3 solution 32, to absorb 3.755 kg/minute of NH3 vapor 44 at 5 C, 2.31 atm. In another loop, 9.001 kg/minute of butane liquid 45 may be heat exchanged (not shown) from 10 C to 37.1 C and fed by pump 46 through coil 41 in absorber 37. The butane vapor 47 at 55 C, 5.57 atm may be expanded in turbine 25 coupled to generator 26 to generate 3.348 kW of electricity. Turbine exhaust 48 at 42.1 C, 1.47 atm may be cooled by the heat exchange to 15 C and liquefied through coil 49 in evaporator 42. In this case, the water circulating in coil 43 of evaporator 42 would also be chilled at a rate of 21,460 Btu/hr. Since pump 4 will require 0.115 kW, fan 14 will require 0.102 kW, pump 21 will require 0.004 kW, and pump 46 will require 0.128 kW, the net electricity will be 3.0 kW, and the COP based on the 1,653 Btu/hr supplied will be 6.192. However, when the 21,460 of Btu/hr of additional heat input is taken into account, the COP will be lowered to about 0.443.

It can be seen that one advantage of this system is very little high-temperature heat energy has to be supplied, while the system itself can also extract low-temperature heat energy from the environment and convert this heat into electricity. In fact, since 1,653 Btu/hr is equivalent to 0.485 kW, if only 16.2% of net the generated electricity were used to provide the high-temperature heat, all of the energy required would have been extracted from the environment to produce the remaining 83.8%.

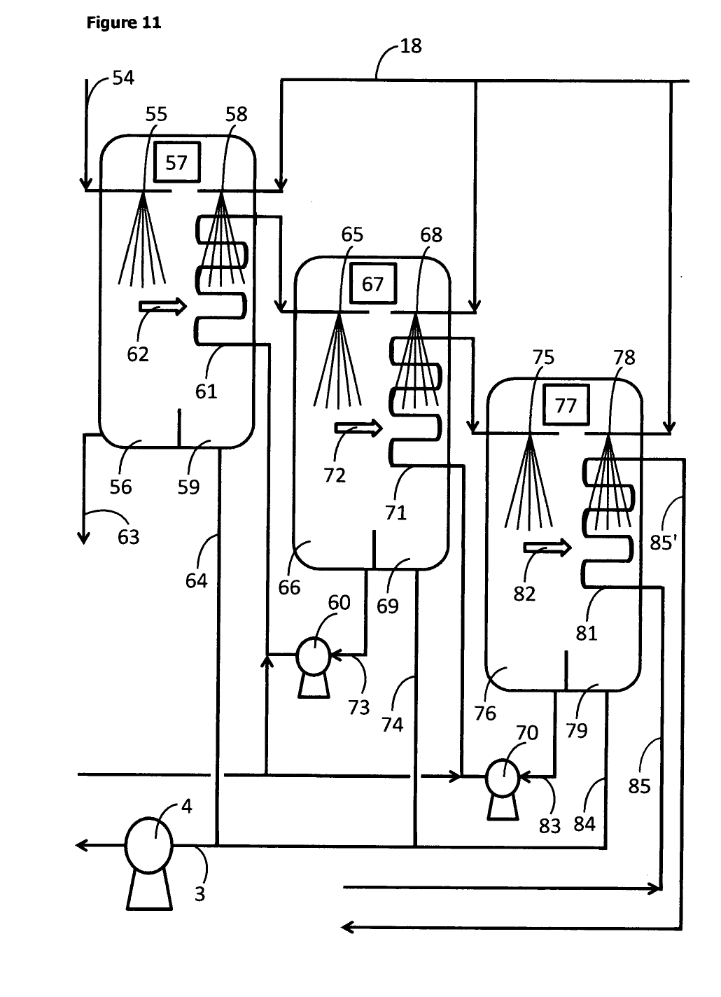

The electricity generation process based on absorption refrigeration which uses a desiccant solution depicted in FIG. 8 can also utilize low-temperature heat energy, but this would require a low-temperature heat energy upgrading process such as the one shown in FIG. 11. For example: 3.283 L/minute of sea water 54 at 22 C may be sprayed through nozzle 55 in evaporating chamber 56 of evaporator/absorber 57, while 0.206 kg/minute of 66.5% NaOH solution 18 at 152.1 C is sprayed through nozzle 58 in absorbing chamber 59 of the evaporator/absorber, and pump 60 circulates water through cooling coil 61 in the absorbing chamber 0.087 kg/minute of water vapor 62 will evaporate from the feed stream 54, chilling the remaining water 63 which leaves the bottom of evaporating chamber 56 to 7 C. The water vapor 62 at 5 C and 0.011 atm will be absorbed into the desiccant solution 18 at 70.2 C, 0.006 atm, and diluted solution 64 will leave the bottom of absorbing chamber 59. Similarly, the heated water from coil 61 may be sprayed through nozzle 65 in evaporating chamber 66 of evaporator/absorber 67, while 0.267 kg/minute of 66.5% NaOH solution 18 at 152.1 C is sprayed through nozzle 68 in absorbing chamber 69 of the evaporator/absorber, and pump 70 circulates water through cooling coil 71 in the absorbing chamber. 0.112 kg/minute of water vapor 72 will evaporate, cooling the remaining water 73 which is recirculated by pump 70. The water vapor 72 at 65.2 C, 0.271 atm will be absorbed into the desiccant solution 18 at 132.7 C, 0.165 atm, and diluted solution 74 will leave the bottom of absorbing chamber 69. Again, the heated water from coil 71 may be fed to spray nozzle 75 in evaporating chamber 76 of evaporator/absorber 77, while 0.256 kg/30 minute of 66.5% NaOH solution 18 at 152.1 C is sprayed through nozzle 78 in absorbing chamber 79 of the evaporator/absorber, and 4.206 L/minute of water 85 at 198 C is circulated through cooling coil 81 in the absorbing chamber. 0.107 kg/minute of water vapor 82 will evaporate, cooling the remaining water 83 which is recirculated by pump 80. The water vapor 82 at 127.7 C, 2.84 atm will be absorbed into the desiccant solution 18 at 210 C, 1.73 atm, and diluted solution 84 will leave the bottom of absorbing chamber 79. The water 85 will be heated in coil 81 to 208 C. The diluted solutions 64, 74, 84 may be combined into 1.035 kg/minute of 46.9% NaOH solution 3 at 142.1 C and fed by pump 4 to re-concentration (not shown). It should suffice to say that the re-concentration will require 1,981 Btu/hr at 400 C. Thus, 11,713 Btu/hr has been extracted from the sea water and upgraded to the 10,006 Btu/hr required by the process depicted in FIG. 8 to generate 3.0 kW of electricity, using only 1,981 Btu/hr, which is equivalent to 0.581 kW or only 19.4% of the 3.0 kW.

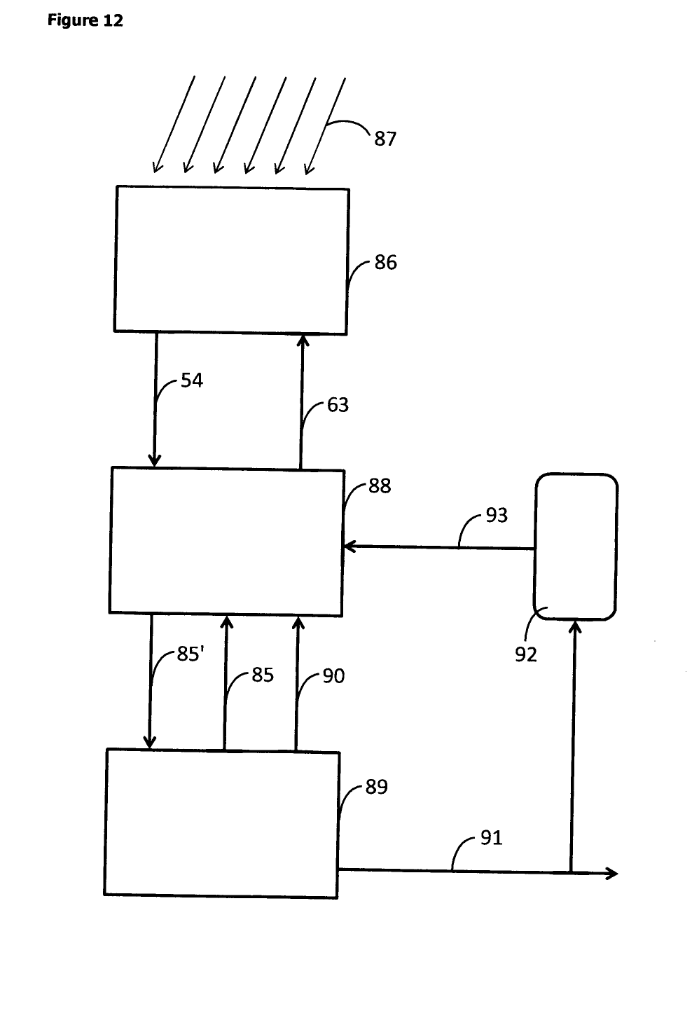

FIG. 12 has shown a possible integration of the low-temperature heat energy upgrading process depicted in FIG. 11 with the electricity generation process depicted in FIG. 8 on a larger scale. For example, solar pond 86 on an area of 1 rai (1,600 m2) may receive 250 Btu/hr/ft2 of solar radiation 87 to heat cold water 63 at 7 C from low-temperature heat energy upgrading process 88 and provide heated water 54 back at 22 C, 4,305,564 Btu/hr. The low-temperature heat upgrading process 88 may upgrade this to heat a heat transfer medium 85 at 198 C from electricity generation process 89 and provide the medium 85′ back at 208 C, 3,678,167 Btu/hr. The electricity generation process 89 in turn may use this to generate 1,290.9 kW, provide 344.5 kW of electricity 90 to the low-temperature heat upgrading process 88, and export 946.4 kW of net electricity 91. 277.6 kW of the electricity 90 will be used by the low-temperature heat upgrading process 88 to produce 947,065 Btu/hr at 400 C, 90% efficiency, and the remaining 66.9 kW will be for motive power. When the electricity demand is low, some of the electricity 91 may be used to heat a heat storage material in heat storage tank 92, and when the demand peaks, heat 93 from the heat storage tank 92 could be used in place of the 277.6 kW to increase the available electricity to 1,224 kW (an increase of 29.3%). The overall COP based on the 4,305,564 Btu/hr of heat input and the 946.4 kW of electricity 91 will be 0.750. Although the COP is lowered compared to COP of 1 in the process of FIG. 8, the much simpler low-temperature heat energy collection will reduce the initial investment cost over a wide area. Furthermore, with adequately large solar pond 86, the system can be operated both day and night, and if ambient air is warm enough, the cold water 63 could be used to extract the heat from the air without having to use any area for the solar pond 86 at all.

The evaporating chamber 13 in all of the above drawings could be a packed or a trayed column, although over separation of the feed stream components may reduce the COP under certain circumstances. The circulation of the gaseous medium between the evaporating chamber 13 and the condensing chamber 6 could also be effected by natural draft instead of induced draft. The amount of the circulating gaseous medium could be very small, especially at extremely high temperatures, and in fact could even be provided by the gases dissolved in the feed stream 3 itself. The stream 18 leaving the evaporating chamber 13 may initially exchange heat with the circulating gaseous medium 5 entering the chamber without exchanging mass, for example, as described in U.S. Pat. No. 1,920,682 (Humbert Frossard de Saugy, FR, 1931). Other features disclosed in U.S. Pat. No. 614,776, U.S. Pat. No. 3,345,272, U.S. Pat. No. 3,317,406, U.S. Pat. No. 3,522,151, U.S. Pat. No. 3,822,191, U.S. Pat. No. 3,860,492, U.S. Pat. No. 4,363,703, U.S. Pat. No. 4,832,115, and U.S. Pat. No. 4,982,782 cited earlier could also be incorporated. The electricity generation process depicted in FIG. 8 or 10 could provide the motive power for the fresh-water production process depicted in FIG. 4, and the low-temperature heat upgrading process depicted in FIG. 11 may be integrated with other processes as well.

Even though the present invention has been described in conjunction with specific embodiments, those skilled in the art would readily appreciate that numerous modifications and variations can still be made within the spirit and the scope there of, and it would be practically impossible to elucidate all of these possible modifications and variations, including their possible combinations.

### BEST MODES FOR CARRYING OUT THE INVENTION

Same as described with respect to the embodiments shown in the Figures.

1. A devolatilization/solution concentration process, said process comprises (a) pre-heating a feed stream from a 1st temperature to a 2nd temperature, (b) providing additional heat to the pre-heated stream, (c) evaporating a portion of the heated stream into a circulating gaseous medium to cool the remaining, concentrated stream to a 4th temperature, (d) condensing vapor in the circulating gaseous medium from step (c) to provide said pre-heating of the feed stream in step (a) and produce a condensed stream, and (e) optionally recycling at least a part of the vapor-depleted gaseous medium from step (d) to step (c), wherein at least a part of the evaporation into the circulating gaseous medium in step (c) takes place at a 3rd temperature, which is higher than the normal boiling point of the feed stream.

2. A devolatilization/solution concentration process according to claim 1, wherein said 3rd temperature is just slightly higher than said 2nd temperature, and said 4th temperature is just slightly higher than said 1st temperature.

3. A devolatilization/solution concentration process according to claim 1, wherein said feed stream comprises a dilute aqueous solution containing a dissolved desiccant.

4. A devolatilization/solution concentration process according to claim 3, wherein the cooled, concentrated desiccant solution is further used in the capture of moisture from the air, in the drying of a wet material, in air conditioning/refrigeration, in the conversion of low-temperature heat energy to high-temperature heat energy, and/or in electricity generation.

5. A devolatilization/solution concentration process according to claim 1, wherein said feed stream comprises a rich aqueous solution containing a relatively high amount of a dissolved volatile-matter.

6. A devolatilization/solution concentration process according to claim 5, wherein the condensed volatile-matter stream is further used in air conditioning/refrigeration, in the conversion of low-temperature heat energy to high-temperature heat energy, and/or in electricity generation.
